(19) United States
(12) Patent Application Publication
(10) Pub. No.: US 2003/0133010 A1
(43) Pub. Date: Jul. 17, 2003

(54) APPARATUS FOR DISPLAYING IMAGES RECORDED BY CAMERA

(76) Inventor: SHINICHI HAGIWARA, YOKOHAMA-SHI (JP)

Correspondence Address: FITZPATRICK CELLA HARPER & SCINTO, 30 ROCKEFELLER PLAZA, NEW YORK, NY, 10112, US

(21) Appl. No.: 09/270,844

(22) Filed: Mar. 18, 1999

(30) Foreign Application Priority Data
Mar. 31, 1998 (JP) 101732/1998

(51) Int. Cl. H04N 5/253

(52) U.S. Cl. 348/96; 396/310

(57) ABSTRACT

An apparatus displays images recorded by a camera. The apparatus includes a reading unit and an output unit. The reading unit reads information of focus areas used in image capture. The output unit outputs, based on the information read by the reading unit, signals for displaying the images.

### BACKGROUND OF THE INVENTION

1. Field of the Invention

The present invention relates to improved image reproduction apparatuses for capturing images from a developed photographic film, and outputting the images in the form of video signals to a display such as a television monitor.

2. Description of the Related Art

Conventional photo-video players for performing image capture from a developed photographic film having a plurality of recorded images, and outputting images as video signals to an image display apparatus, are known.

By way of example, electronic apparatuses for performing image-reproduction control based on magnetic information on a photographic film proposed in Japanese Patent Laid-Open Nos. 8-129236 and 9-102908 correspond to the photo-video players. The electronic album apparatus disclosed in Japanese Patent Laid-Open No. 8-129236 reproduces image information recorded on a developed photographic film having a magnetic information part by converting the image information into electrical signals, and controlling, based on the magnetic information, a determination of whether each frame of the film may be reproduced, information on frames to be reproduced in sequential reproduction processes, or a determination of whether zooming or trimming for each frame may be performed. The image display apparatus and camera disclosed in Japanese Patent Laid-Open No. 8-129236 uses recording information written as magnetic information of a photographic film to determine whether displayed images were captured by successive image capture.

As described above, magnetically recorded information is conventionally used as a simple switch for displaying or image processing.

FIGS. 21A and 21B illustrate enlargement of an image performed by a conventional image display apparatus.

FIG. 21A shows both an image from a developed photographic film that is displayed on a TV monitor, and a finder view of a camera in order that the relationship between the image and the finder view may be understood. The camera has a finder view factor of 100%, and five focus-condition detection areas, although this example assumes focus detection points (focus detection regions), distance measurement points (distance measurement regions) for focus adjustment may be used. The image was captured by performing focus adjustment at the leftest focus detection point with respect to an airplane as a main subject.

FIG. 21B shows a view enlarged to 200% of the size of the image. In FIG. 21B, for facile comparison with FIG. 21A, the finder view frame, and the focus detection point used are shown at the same positions. Because the finder view factor is 100%, a region on the film matches a region observed from the finder, and matches a region captured by a photo-video player. Thus, the region in the finder view frame matches the region displayed on the TV monitor or the like (though the displayed region is enlarged to 200%). As is clear from FIG. 21B, while the airplane as the main subject is enlarged, only part of the main subject is displayed on the TV monitor. This is simply because the original image was enlarged using its center as a reference point.

The above-described electronic apparatuses simply perform reproduction to a monitor, or control determination of whether zooming for each frame may be performed, irrespective of the contents of images on a photographic film. In zooming, that is, successive enlargement or reduction, the center of an image is used as a reference point. Therefore, in the zooming-in operation of a frame having no main subject in the center as shown in FIG. 21B, a problem occurs in that the main subject is out of a monitor screen.

### SUMMARY OF THE INVENTION

Accordingly, it is an object of the present invention to provide an image reproduction apparatus for solving the foregoing problem.

To this end, according to an aspect of the present invention, the foregoing object has been achieved through provision of an apparatus for displaying images recorded by a camera, the apparatus including a reading unit for reading information on focus areas used for image capture, and an output unit for outputting, based on the information read by the reading unit, signals for displaying the images.

Preferably, the focus area information read by the reading unit represents the position of the focus area used in image capture.

The output unit may process the images recorded by the camera so that the position of the focus area is centered before outputting signals for displaying the processed images.

The output unit may use as a reference point the position of the focus area used in image capture to enlarge the images recorded by the camera before outputting signals for displaying the enlarged images.

The reading unit may include a magnetic head for reading magnetic information recorded on a photographic film for the camera.

According to another aspect of the present invention, the foregoing object has been achieved through provision of an apparatus for displaying images recorded by a camera, the apparatus including: an image-capture sensor for capturing images optically recorded on a photographic film; a reading unit for reading information magnetically recorded on the photographic film; and an output unit for processing and outputting the images captured by the image-capture sensor by using information on a focus area used for image capture from the information read by the reading unit.

Preferably, the apparatus further includes a storage unit for storing the images captured by said image-capture 115 sensor, and the output unit processes and outputs the images stored in the storage unit.

The output unit may process the images recorded by the camera so that the position of said focus area used in image capture is centered before outputting signals for displaying the processed images.

The output unit may use as a reference point the position of the focus area used in image capture to enlarge the images recorded by the camera before outputting signals for displaying the enlarged images.

### BRIEF DESCRIPTION OF THE DRAWINGS

FIG. 1 is an exterior view showing a photo-video player according to embodiments of the present invention, and a TV monitor.

FIG. 2 is a top view showing the internal structure of a main unit constituting the photo-video player shown in FIG. 1.

FIG. 3 is a side view illustrating a photographic film used in the photo-video player shown in FIG. 1, and the reading of magnetic information.

FIG. 4 is a block diagram showing a control system employed in the photo-video player shown in FIG. 1.

FIG. 5 is a top view showing a camera for recording images to be processed by the photo-video player shown in FIG. 1.

FIG. 6 is a view finder of the camera shown in FIG. 5.

FIGS. 7A and 7B are drawings illustrating the relationship between a TV monitor and focus detection points in embodiments of the present invention.

FIG. 8 is a table showing the correspondence between camera indices and arrangements of focus detection points in embodiments of the present invention.

FIG. 9 is a table showing the correspondence between focus detection indices and focus detection points in embodiments of the present invention.

FIG. 10 is a table showing the correspondence among camera types, focus detection points, and the coordinates thereof.

FIG. 11 is a flowchart illustrating sequential operations in the photo-video player shown in FIG. 1.

FIG. 12 is a flowchart illustrating the single-frame reproduction mode of the photo-video player shown in FIG. 1.

FIG. 13 is a flowchart illustrating the enlargement mode of the photo-video player shown in FIG. 1.

FIG. 14 is a diagram illustrating coordinates used when an enlarged image is displayed using, as a reference point, focus detection point AFP1 shown in FIG. 6.

FIG. 15 is a block diagram showing a signal processing circuit in a first embodiment of the present invention.

FIG. 16 is a drawing illustrating interpolation performed when an enlarged image is generated in the horizontal direction in embodiments of the present invention.

FIG. 17 is a drawing illustrating interpolation performed when an enlarged image is generated in the vertical direction in embodiments of the present invention.

FIG. 18 is a drawing showing the case where an image enlarged to 200% of the size of a developed film image in a first embodiment of the present invention.

FIG. 19 is a block diagram showing a control system employed in a photo-video player according to a second embodiment of the present invention.

FIG. 20 is a block diagram showing a signal processing circuit in the photo-video player according to a second embodiment of the present invention.

FIGS. 21A and 21B are drawings illustrating a problem due to the use of a conventional image display unit.

### DESCRIPTION OF THE PREFERRED EMBODIMENTS

The present invention will be described based on embodiments thereof with reference to the attached drawings.

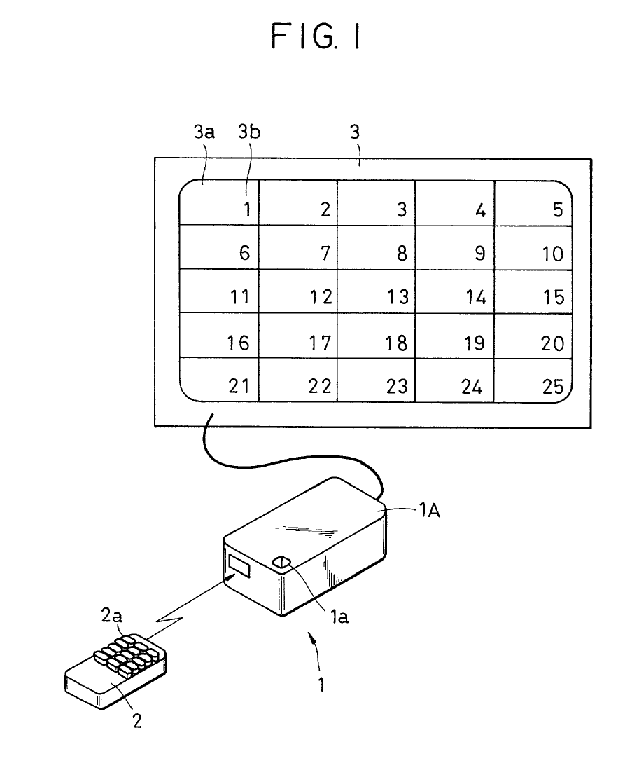

FIG. 1 shows a photo-video player as a type of an image displaying apparatus according to a first embodiment of the present invention.

A photo-video player 1 includes a remote controller 2, and a photo-video-player main unit (hereinafter referred to as a “main unit”) 1A that captures images from a developed photographic film (hereinafter referred to simply as a “film”) in accordance with an operation mode set by infrared signal from the remote controller 2 before outputting the images as video signals to a television (TV) monitor 3.

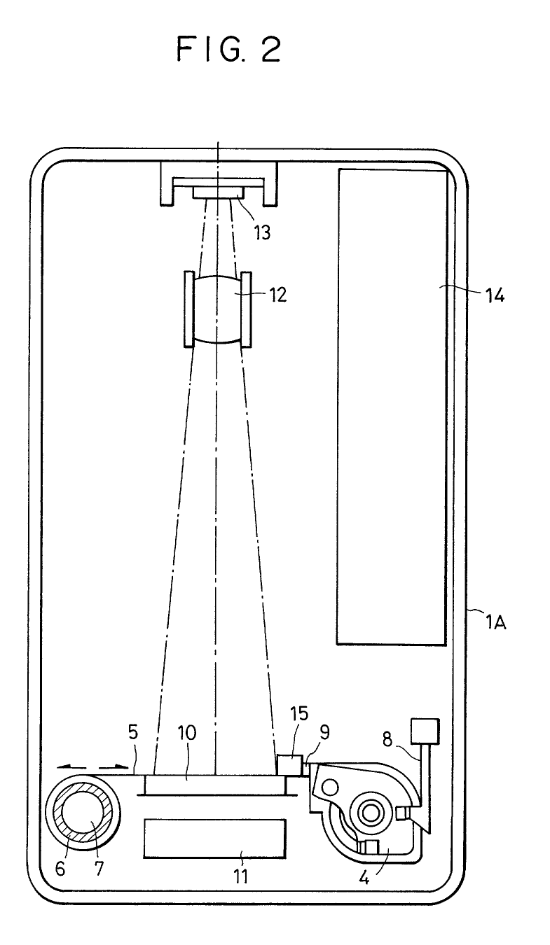

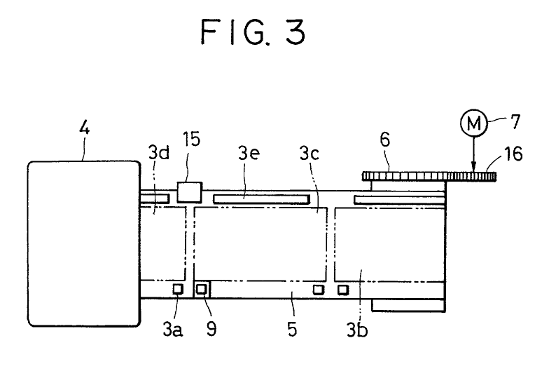

The main unit 1A is covered with a box-shaped casing. The top surface of the casing has a cartridge receiver 1a into which a film cartridge 4 (see FIGS. 2 and 3) is loaded. The remote controller 2 has a ten-key set 2a, and various keys such as operation-mode setting keys. The TV monitor 3 displays, on a screen, based on video signals from the main unit 1A, a plurality of images at the same time, or a single image.

FIG. 2 shows the internal structure of the main unit 1A. FIG. 3 shows a front surface part of a film 5 drawn from the film cartridge 4.

The main unit 1A (shown in FIG. 2) includes a camera unit for capturing images recorded on the film 5, and a control circuit 14 for controlling the camera unit to output video signals to the TV monitor 3.

The camera unit includes: a spool 6 to which the film 5 is wound; a feed motor 7 for feeding the film 5 to the right or to the left by normal or reverse turning the spool 6; a detecting member 8 for detecting the loading of the film cartridge 4; a photo-reflector 9 for detecting movement of the film 5 by counting the number of image frames; a magnetic head 15 for reading magnetic information recorded on magnetic tracks formed on the film 5 or writing new data as magnetic information; a light source 10 for illuminating images on the film 5 with illumination by a light-source driving circuit 11; and an image capture 13 that uses an image capture lens 12 to capture the images illuminated by the light source 10.

Referring to FIGS. 2 and 3, a gear 16 rotates in accordance with the driving of the feed motor 7, and also the spool 6, which is formed so as to be included in the gear 16, rotates. This draws the film 5 from the film cartridge 4. While the film 5 is being fed, the photo-reflector 9 detects perforations 3a, whereby a control circuit 14 determines that each frame (e.g., 3c or 3d) has reached an image capture position (opposed to the image capture lens 12), and stops the driving of the feed motor 7. Accordingly, a predetermined frame of the film 5 is positioned in the image capture position.

When the film 5 is fed by the feed motor 7, the magnetic head 15 reads magnetic information recorded on a magnetic track 3e formed in the film 5, or writes magnetic information on the track 3e.

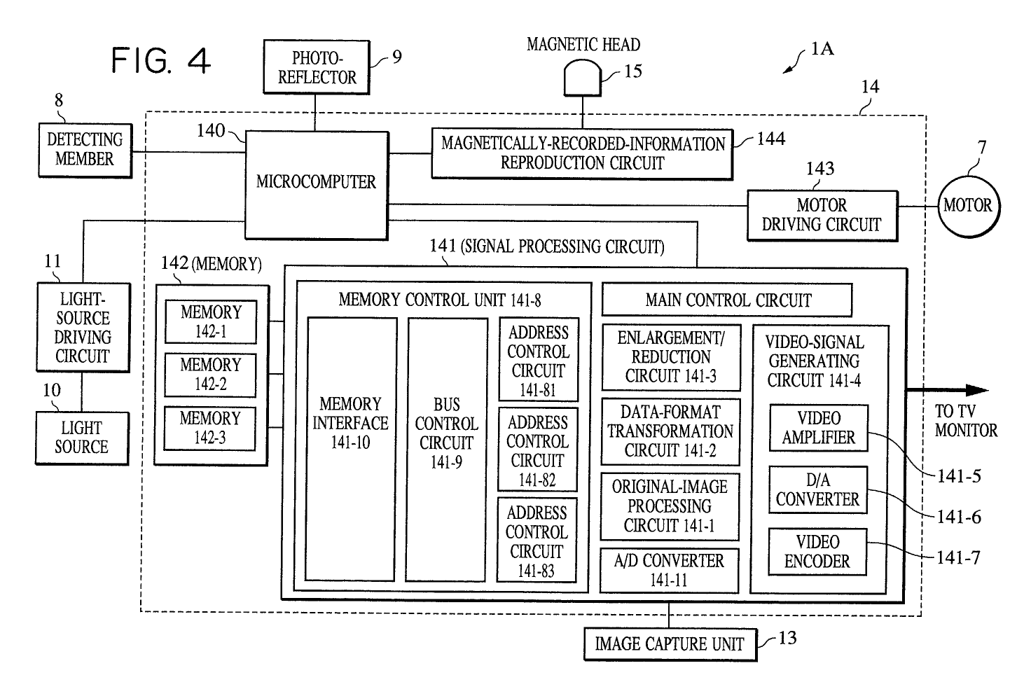

FIG. 4 shows a block diagram of the main unit 1A.

The control circuit 14 includes: a microcomputer 140 for controlling the entire main unit 1A; a signal processing circuit 141 for processing image signals from the image capture unit 13, which includes a charge-coupled-device area sensor, and generates video signals to be output to the TV monitor 3; a memory 142 (described below) for storing image data processed by the signal processing circuit 141; and a motor driving circuit 143 for driving the motor 7.

The signal processing circuit 141, the motor driving circuit 143, the detecting member 8, the photo-reflector 9, the light-source driving circuit 11 and a magnetically-recorded-information reproduction circuit 144, are connected to the microcomputer 140.

The microcomputer 140 is a single-chip microcomputer including, for example, a central processing unit (CPU), a random access memory (RAM), a read-only memory (ROM), an electrically erasable programmable read-only memory (EEPROM), and input and output ports.

The microcomputer 140 performs a series of processes based on a sequence program stored in its ROM. Specifically, the microcomputer 140 controls the image capture unit 13 and the signal processing unit 141 so that after a plurality of images of the film 5 is captured and output as video signals for simultaneously displaying the plurality of images, one image on the film 5 is captured and output as video signals for displaying the one image to the TV monitor 3. The microcomputer 140 can output a signal for displaying a frame number at the same time the video signals for simultaneously displaying a plurality of images are output.

The signal processing circuit 141 has an analog-to-digital (A/D) conversion function, and includes: an original-image processing circuit 141-1 in which noise components in signals from the image capture unit 13 (including the CCD area sensor) that are converted from analog form into digital form are eliminated by a low-pass filter, and a series of image processes such as pixel interpolation, white balance, gamma correction, and a negative-to-positive-form reverse process (if the film 5 is a negative film) are performed; an enlargement/reduction circuit 141-3 for enlarging or reducing (if necessary) image data generated by the image processes; a video-signal generating circuit 141-4 having a digital-to-analog (D/A) converter 141-6, and which includes a video encoder 141-7 and a video amplifier 141-5; and a memory control unit 141-8.

The memory control unit 141-8 includes address control circuits 141-81, 141-82 and 141-83, a bus control circuit 141-9 for controlling address buses and data buses (not shown), and a memory interface 141-10 in order to independently access three memories 142-1, 142-2 and 142-3 constituting the memory 142 (described below). The address control circuits 141-81, 141-82 and 141-83 correspond to the memories 142-1, 142-2 and 142-3, respectively, and perform address control related to memory-access operations such as writing to or reading from each memory. The bus control circuit 141-9 controls the address buses and the data buses so that image data pre-stored from the image capture unit 13 into the memory 142-1 are read and sent to the video-signal generating circuit for outputting the image data to the TV monitor 3, and so that after the image of a next frame to be displayed is stored from the image capture unit 13 into the memory 142-2 via the A/D converter 141-11, original-image processing in each unit number of pixels is performed using a plurality of images as a unit in order to control writing to the memory 142-3.

The memory 142 includes the three memories 142-1, 142-2 and 142-3 that can be independently accessed. In each memory, image data for one frame, captured by the image capture unit 13, are stored.

Each of the above-described functions is activated in accordance with control signals from the microcomputer 140.

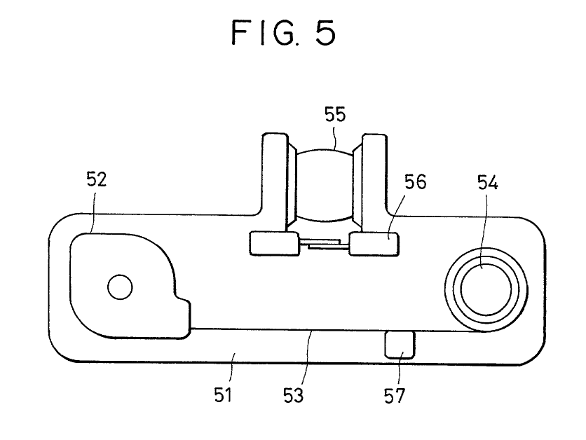

The detailed operation of the signal processing circuit 141 is described below with reference to FIG. 5.

FIG. 5 shows a cross section of a camera having five focus detection points, which can record focus-detection and focus-adjustment information in an image capture mode. The camera includes a camera body 51, a film cartridge 52 (corresponding to the film cartridge 4 shown in FIG. 3) into which film is loaded. The film 53 is drawn from the film cartridge 52 by a spool 54.

The film 53 is coated with a belt of magnetic material so that a magnetic track is formed. A magnetic signal can be recorded on the magnetic track. A magnetic head 57 records information obtained in an image capture mode, such as a focus detection index and a camera ID, in a predetermined position (outside an image capture screen) corresponding to each frame on the magnetic track.

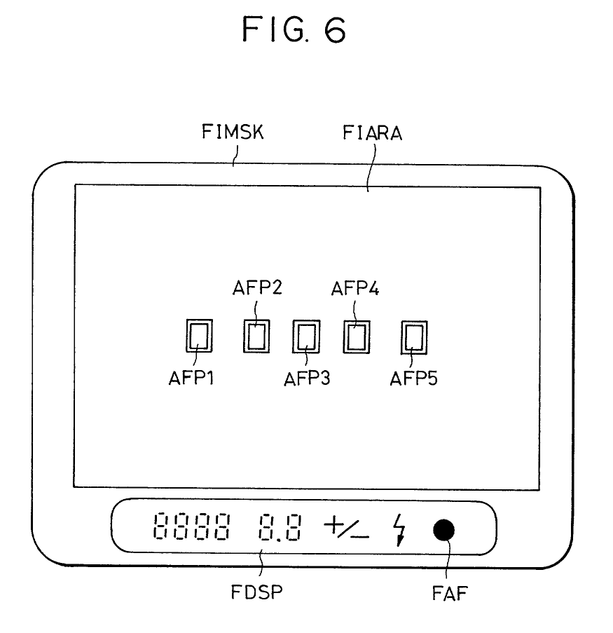

The camera has five focus detection points AFP1 to AFP5 (the positions of which are described below with reference to FIG. 6). 3-bit information is used to record, as focus detection indices, focus detection points used in an image capture mode. Specifically, bits “000” represents focus detection point AFP1, bits “001” represents focus detection point AFP2, bits “010” represents focus detection point AFP3, bits “011” represents focus detection point AFP4, and bits “100” represents focus detection point AFP5.

FIG. 6 shows a view finder of the camera. Positional relationships between focus detection points AFP1 to AFP5 and the finder view are described with reference to FIG. 6. Although a focus detector is closely related to focus detection points, its description is omitted since its operation is not particularly related to the present invention.

In FIG. 6, the view finder includes a view mask FIMSK forming a view finder region, and an observation region FIARA in which a subject can be observed through a mounted lens. From among five focus detection points AFP1 to AFP5 in the observation region FIARA, an arbitrary focus detection point can be selected for image capture.

Focus detection points AFP1 to AFP5 correspond to pairs of line sensors constituting the focus detector (not shown). At each focus detection point, the condition of focussing can be independently detected. When focus detection points AFP1 to AFP5 each are selected for focus adjustment, a region between the outer rectangle and the inner rectangle of each focus detection point is illuminated by an optical system and illuminating device (not shown) to flash red in a short time for allowing a photographer to sufficiently recognize it.

An in-finder liquid crystal display FDSP lights to display image capture information: a shutter speed; a lens stop value; an exposure correction value; a strobe-ready condition; and a focus detection result. The focus detection result is indicated by the brightness condition of focus mark FAF. Focus mark FAF lights to indicate a focussed condition, or flashes to indicate incapability of focus adjustment.

In FIG. 6, all the indications are activated independently. When the camera operates, each indication is independently activated or inactivated, so that all the indications are not activated as shown in FIG. 6.

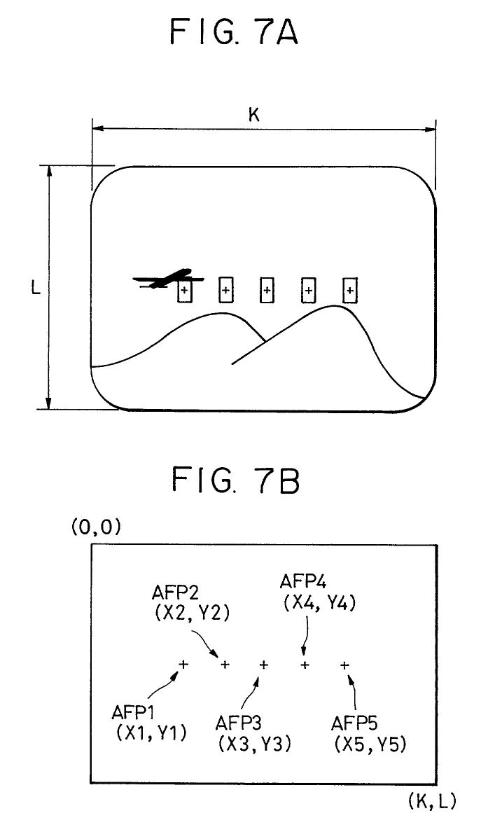

Next, with reference to FIGS. 7A and 7B, relationships between images captured by a photo-video player, which are recorded on a film, and images viewed from the finder in an image capture mode, are described.

In the case where image capture using a photo-video player from a film having images captured by a camera having a view finder factor of 100% is performed, the images captured and viewed from the camera finder are reproduced unchanged. Accordingly, the positions of focus detection points in a screen are identical to those of them in a view from the finder.

FIG. 7A shows the positions of the focus detection points, which are obtained when image capture is performed using an image sensor having K×L pixels as an effective region. FIG. 7B shows positional addresses on the image sensor that represent the positions of the focus detection points, and illustrates the correspondences between the centers of the focus detection points in a view from the camera finder, and positions of an image captured by the image sensor of the image capture unit 13.

In FIG. 7B, the top left corner is represented by positional address (0, 0), and the bottom right corner is represented by positional address (K, L). When the centers of the focus detection points on the image sensor are found, the focus detection points AFP1 to AFP5 are respectively represented by positional addresses (X1, Y1) to (X5, Y5).

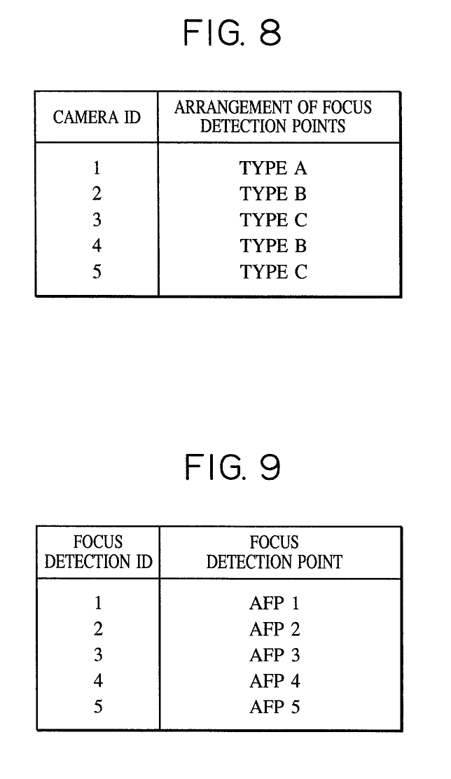

Next, FIGS. 8 to 10 are described.

FIG. 8 shows the relationships between camera ID recorded on the magnetic track of the film, and arrangements of focus detection points. For example, “camera ID=3” means that the arrangement of focus detection points is “type C”.

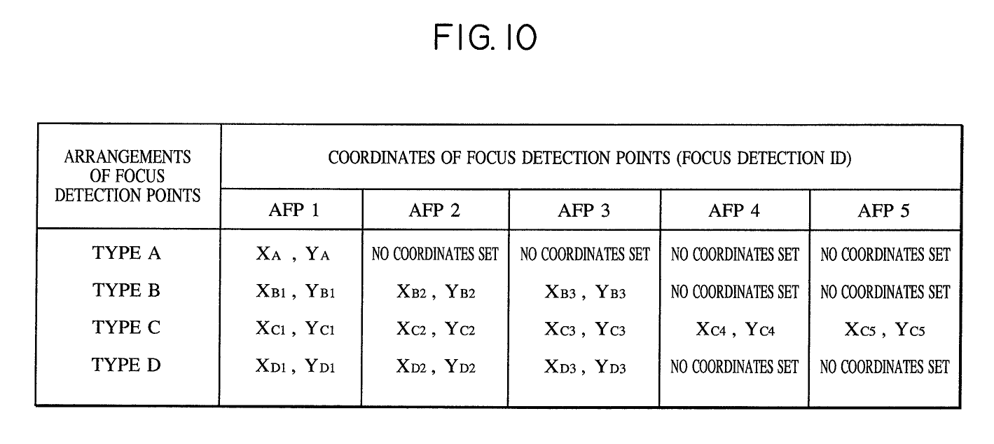

FIG. 9 shows the relationships between focus detection ID recorded on the magnetic track of the film, and focus detection points used in image capture. For example, “focus detection ID=1” means that focus adjustment at “focus detection point AFP1” was performed for image capture.

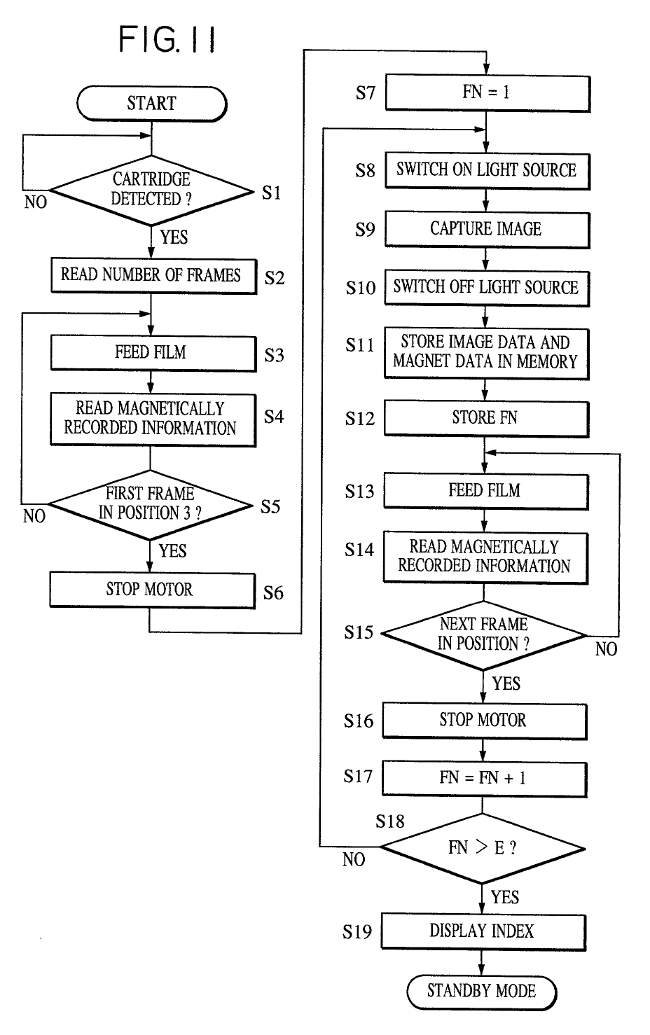

FIG. 10 shows the relationships between arrangements of focus detection points and the coordinates of the centers of focus detection points on image data captured from the image capture unit 13.

By way of example, the arrangement of focus detection points, “type A”, corresponds to only one set focus detection point AFP1, and the coordinates of AFP1 in the image data obtained from the image capture unit 13 are (X_{A}, Y_{A}) The arrangement of focus detection points, “type C”, corresponds to five focus detection points from AFP1 to AFP5, and the coordinates of AFP1 and AFP2 in the image data obtained from the image capture unit 13 are (X_{C1}, Y_{C1}) and (X_{C2}, Y_{C2}), respectively. Arrangements of focus detection points, both “type B” and “type D”, correspond to three focus detection points, and coordinates in the image data obtained from the image capture unit 13 mutually differ.

The relationships (shown in FIGS. 8 to 10) are stored in the EEPROM of the microcomputer 140. In the case where a new camera ID is necessary, the new camera ID can be additionally written to the stored relationships.

By using the camera ID, the focus detection ID, and the relationships shown in FIGS. 8 to 10, coordinate data on focus detection points in a two-dimensional image captured from the image capture unit 13 can be found.

Next, the operation of the photo-video player according to the first embodiment is described with reference to the flowcharts shown in FIGS. 11 to 13.

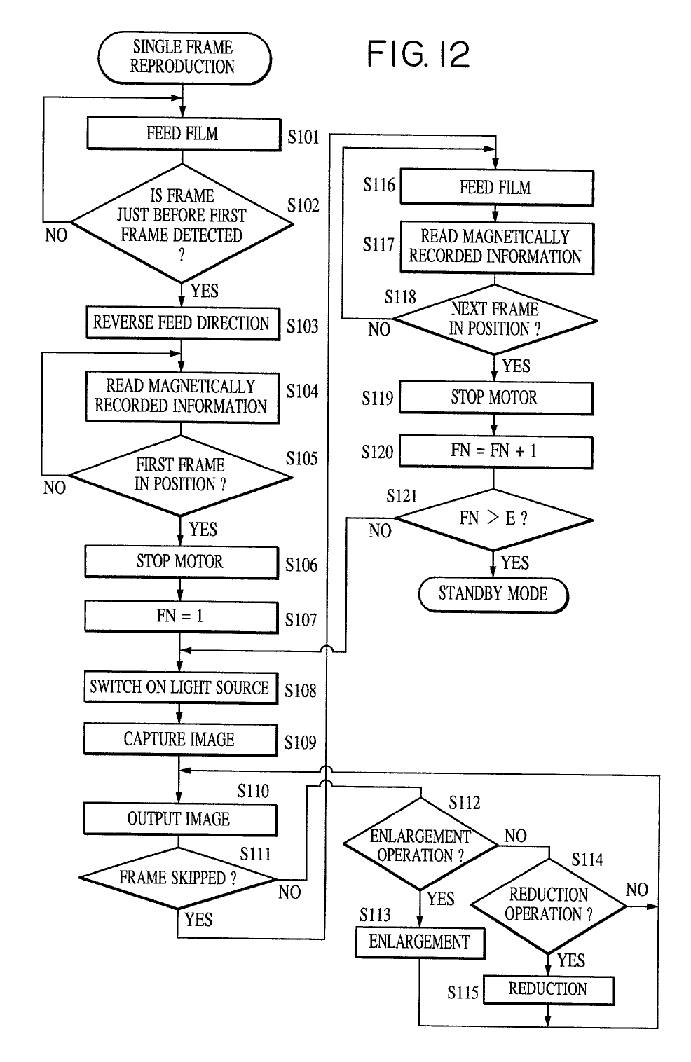

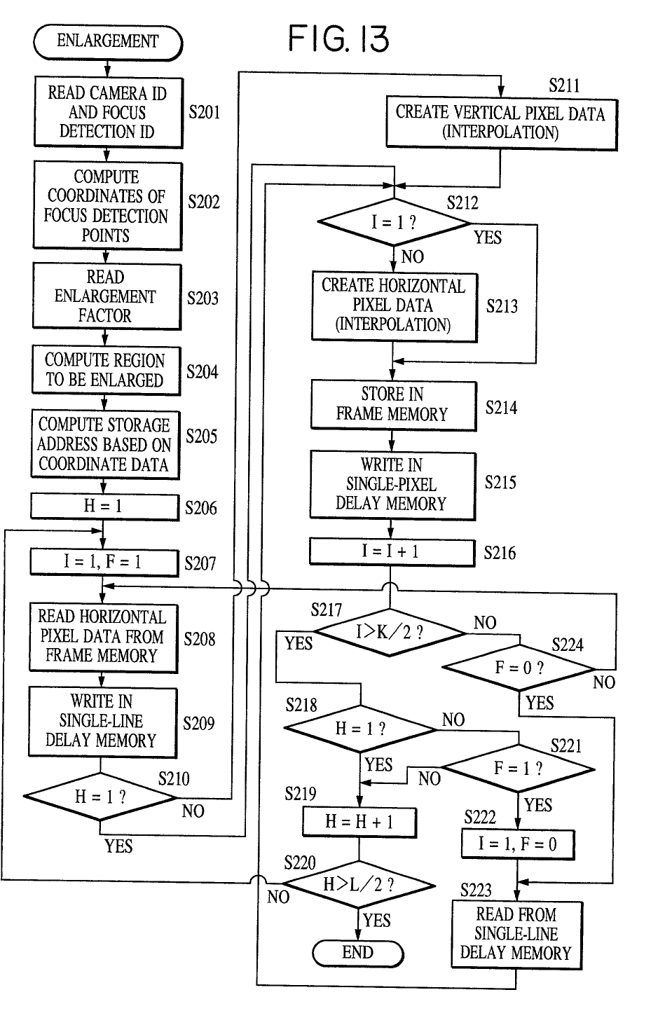

FIG. 11 shows a process comprised of sequential steps performed by the photo-video player from film loading to index display. FIG. 12 shows a process comprised of sequential steps performed by the photo-video player, in which a single-frame reproduction mode is selected with remote operation, and single-frame reproduction is performed. FIG. 13 shows a process comprised of sequential steps in which from the displaying of a single frame in the single-reproduction mode shown in FIG. 12, remote control is used to perform frame enlargement.

In the process shown in FIG. 11, a user inserts the film cartridge 4 having the film 5 on which a plurality of images are recorded, into the cartridge receiver 1a of the main unit 1 so that the film cartridge 4 is in a predetermined position. Then, the detecting member 9 detects the setting of the film cartridge 4, and sends a detection signal to the microcomputer 140 in the control circuit 14. Based on the detection signal, the microcomputer 140 detects the setting of the film cartridge 4 (step S1), and simultaneously reads, based on another detection signal from a data reading means (not shown), the number E of captured image frames that is recorded in the film cartridge 4 (step S2). The microcomputer 140 initiates the feeding of the film 5 by controlling the motor driving circuit 143 to supply power to the feed motor 7 (step S3), and initiates the reading of magnetically recorded data by using the magnetically-recorded-information reproduction circuit 144 to drive the magnetic head 15 (step S4).

When the film 5 is fed by the feed motor 7, and the first frame of the film 5 reaches the front of the light source 10, the microcomputer 140 finds based on the feeding amount of the film 5 measured by the photo-reflector 9 that the first frame has reached the front of the light source 10 (“YES” in step S5). At this time, the microcomputer 140 controls the motor driving circuit 143 to stop the feed motor 7 (step S6), and stops the reading of the magnetically recorded data by stopping the driving of the magnetic head 15.

The microcomputer 140 sets value FN of a frame counter at “1” (step S7), and the light source 10 is switched on by driving the light-source driving circuit 11 (step S8). After the image in the first frame is illuminated and is captured by the image capture unit 13 (step S9), the light source 10 is switched off (step S10). First-frame image data processed by the signal processing circuit 141, and information read by the magnetic head 15 are recorded in the memory 142 (step S11). Image capture in step S9 and recording in step S11 is arranged to simultaneously display a plurality of images on the TV monitor 3 in a subsequent step. In the first embodiment, 25 images can be simultaneously displayed on the TV monitor 3, as shown in FIG. 1. The number of pixels on the screen of the TV monitor 3 is always the same. Thus, in order that 25 images may be displayed on the screen of the TV monitor 3, the number of pixels for each image to be displayed is decreased to be 1/25 of the number of pixels used for normally displaying an image on the screen of the TV monitor 3.

Value FN of the frame counter recorded in the memory 142 is stored in a memory in the microcomputer 140 (step S12), and while the film 5 is being fed so that the next frame is positioned in front of the light source 10, the reading of the magnetically recorded information is performed (steps S13, S14, and S15). When the next frame reaches the predetermined image capture position, the motor 7 is stopped (step S16).

The microcomputer 140 increases value FN of the frame counter (FN=FN+1) (step S17), and determines whether updated value FN is equal to the number E of image capture frames read in step S2 (step S18). If updated value FN is less than number E, the microcomputer 140 returns to step S8 for repeatedly performing the same image capture operations.

If the microcomputer 140 has determined that updated value FN is equal to number E, among the images recorded in the memory 142, images for a number of (25) frames that can be simultaneously displayed on the TV monitor 3 are output, together with output signals for an index screen simultaneously displaying the frame numbers corresponding to the images, and value FN (step S19).

Thereby, on the TV monitor 3, images 3a, frame numbers 3b, and values FN, 3b, are simultaneously displayed as shown in FIG. 1. Subsequently, when the user presses the operation-mode switch key of the remote controller 2 to switch the operation mode (frame reproduction mode), the operation mode is switched to the single-frame reproduction mode illustrated in FIG. 12.

Next, the single-frame reproduction mode, in which each frame is sequentially displayed, is described with reference to the flowchart in FIG. 12.

When the single-frame reproduction mode is selected with the remote controller 2, the microcomputer 140 initiates the rewinding of the film 5 by controlling the motor driving circuit 143 to supply power to the feed motor 7 (step S101). After a frame (having no image) just before the first frame of the film 5 is detected by the photo-reflector 9 (“YES” in step S102), the feed direction of the film 5 is reversed (step S103), and the reading of magnetic information is started (step S104). The microcomputer 140 determines whether the first frame has reached the front of the light source 10 (step S105). Here, since the capturing of all the images of the film 5 in order to display an index screen is already completed, the film 5 is fed in the rewinding direction. Subsequently, when the microcomputer 140 finds based on the feeding amount of the film 5 measured by the photo-reflector 9 that the first frame has reached the front of the light source 10 which is a predetermined image capture position (“YES” in step S105), the motor driving circuit 143 is controlled to stop the motor 7 (step S106).

The microcomputer 140 sets value FN of the frame counter at “1” (step S107), and uses the light-source driving circuit 11 to activate the light source 10 (step S108). With the image in the first frame illuminated, it is captured and stored in the memory 142-1 by the signal processing circuit 141, and image data in a data format enabling the image in the memory 142-1 to be output to the video-signal generating circuit are stored in the memory 142-2 (step S109). In addition, the signal processing of the image data stored in the memory 142-2 by the signal processing circuit 141 is performed, and the processed data are output to the TV monitor 3 (step S110).

Next, while the first frame image is being displayed on the TV monitor 3, a signal from the remote controller 2 is recognized (steps S111 and S112).

The types of operations by the remote controller 2 are frame skipping, enlargement, and reduction. When frame skipping is not instructed but enlargement is instructed, enlargement is performed (steps S112 and S113), and enlarged image data are displayed on the TV monitor 3 (step S110). When reduction is instructed, reduction is performed (steps S112, S114, and S115), and reduced image data are displayed on the TV monitor 3 (step S109).

The above descriptions are about simple single-frame reproduction. For the switching of the output image to the second frame, the following operation of the signal processing circuit 141 is performed.

Similar to the processing of the first frame, an image processed by original-image processing is stored in the memory 142-1, and the image in the memory 142-1 is stored in the memory 142-3 in a data format enabling the image in the memory 142-1 to be output to the video-signal generating circuit. Subsequently, by switching the output to the video-signal generating circuit from the memory 142-2 containing the first frame image data, to the memory 142-3 containing the second frame image data, the image displayed on the TV monitor 3 is switched from the first frame to the second frame.

In other words, when frame skipping is instructed, the following operations are performed. The film 5 is fed so that the second frame is positioned in front of the light source 10 (step S116), and the reading of magnetically recorded information is performed (step S117). With the frame position of the film 5 detected by the photo-reflector 9, when it is found that the second frame has reached the front of the light source 10 that is a predetermined image capture position (“YES” in step S118), the motor driving circuit 143 is controlled to stop the motor 7 (step S119).

The microcomputer 140 increases value FN of the frame counter (FN=FN+1) (step S120), and determines whether updated value FN is equal to number E read in step S2 (step S121). If value FN is less than number E, the microcomputer 140 returns to step S108, and repeatedly performs the same image operations for image capture and image-data display.

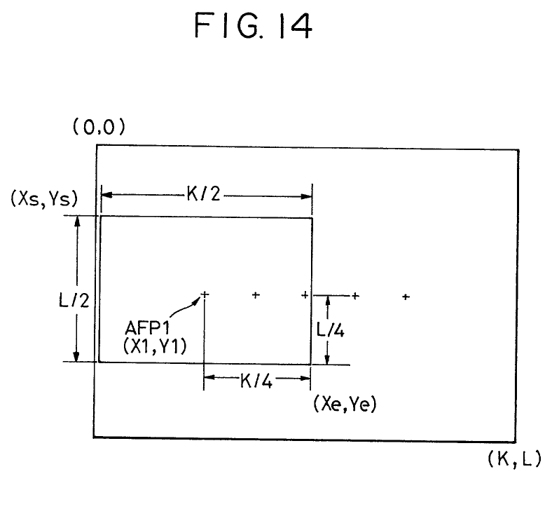

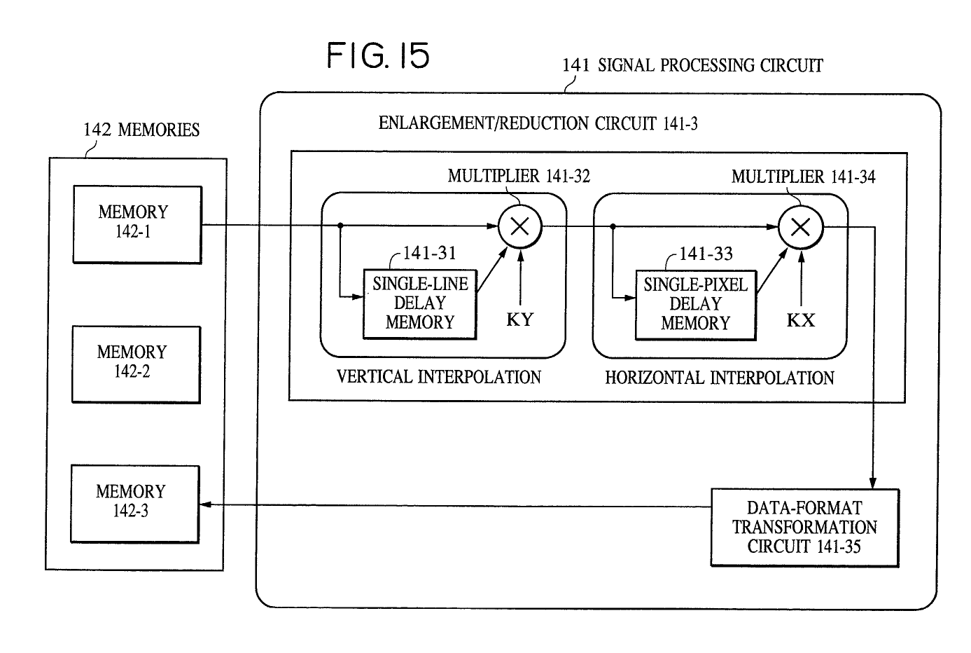

FIG. 13 shows the enlargement step (S113) in the flowchart shown in FIG. 12. FIG. 14 shows a region to be enlarged in the case where a frame with its focus detection performed using focus detection point AFP1 is enlarged at an enlargement factor of 200%.

FIGS. 4, 13 and 14 are used to describe operations performed in the enlargement step.

Based on a control signal from the main control circuit controlled by the microcomputer 140, image data from the image capture unit 13 are converted from analog form into digital form before being processed by original-image processes such as gamma correction, and the processed data are stored in the memory 142-1 under control of the memory control unit. The memory 142-2 contains image data in a data format enabling the data in the memory 142-1 to be output to the video-signal generating circuit.

The image displayed on the TV monitor 3 is obtained by outputting the data in the memory 142-2 via the video-signal generating circuit such as the video encoder. The memory 142-2 is accessed for repetitive reading at a cycle in accordance with a video frequency.

When the enlargement step is executed, the microcomputer 140 performs reading in step S104 or S117 (in FIG. 12), and subsequently reads camera ID and focus detection ID from the magnetically recorded information stored in the internal memory of the microcomputer 140 (step S201). The microcomputer 140 determines an arrangement of focus detection points used for image capture by comparing the read camera ID with the relationships shown in FIG. 8, and finds focus-detection-point information by comparing the read focus detection ID with the relationships shown in FIG. 9. By comparing the obtained arrangement of focus detection points and the obtained focus-detection-point information with the relationships shown in FIG. 10, the coordinates of focus detection points in the image captured by the image capture unit 13, which points correspond to the positions of focus detection points in the finder view, are found (step S202). Here, the case where camera ID 3 and focus detection ID=3 is described with reference to FIG. 13.

The microcomputer 140 reads an enlargement factor prerecorded in its memory (step S203), and computes a region to be enlarged (step S204). A region to be enlarged corresponding to an enlargement factor of 200% is shown in FIG. 14. The region to be enlarged has K/2 in its horizontal direction and L/2 in its vertical direction around the coordinates of focus detection point AFP1 used for focus adjustment. This area is displayed on the entire screen of the TV monitor 3. Consequently, an image having an enlargement factor of 200% can be obtained.

The address of the computed region, stored in the memory 142-1 as a frame memory constituting the memory 142, is computed based on predetermined storing form (step S205). When reading from the memory 142-1 is performed, variable H is set at “1” representing the first one horizontal direction, namely, the first line (step S206), and variable I representing the permutation of pixels is set at “1” and flag F representing reading from the memory is set at “1” (step S207).

Pixel data on the first line are read based on the address computed in step S205 via the memory control unit (step S208), and the read, first pixel data are written in a single-line delay memory 141-31 (step S209). When H=1 (“YES” in step S210), the first pixel data for the first line are written in the single-pixel delay memory 141-33 shown in FIG. 15 (step S211), and because I=1 (step S212), the pixel data are transformed in data format before being stored as the first pixel on the first line after enlargement in the memory 142-3 (steps S214 and S215).

The single-pixel delay memory, and the second pixel data on the first line are used in interpolation for creating the second pixel on the first line after enlargement.

The signal processing circuit 141 includes a data-format transformation circuit 141-35 as shown in FIG. 15, and after the data in the memory 142-1 are output to the data-format transformation circuit, the output data are transformed to have an input format to the video-signal generating circuit, and are stored as the first pixel data on the first line after enlargement in the memory 142-3.

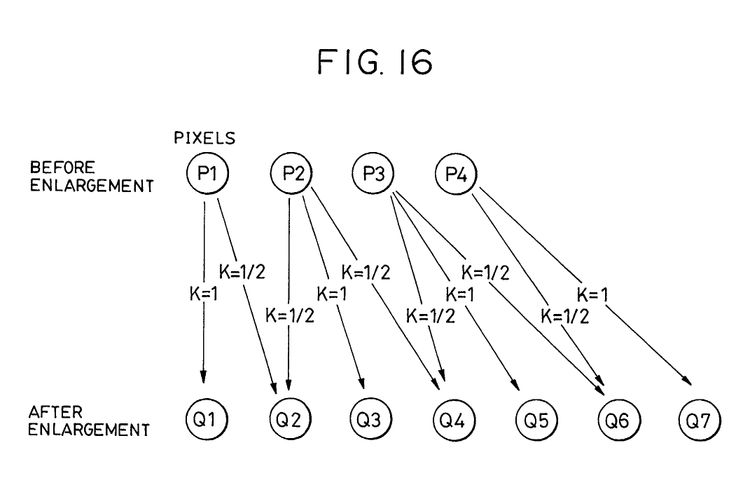

For generating the second pixel data on the first line after enlargement, 1 is added to variable I (step S216), and it is determined whether variable I represents the K/2-th pixel as the last pixel on the first line (step S217). Since variable I presently represents the first pixel, step S224 is executed in which flag F is inspected. Presently, F=1 in step S207. Accordingly, step S208 is executed in which the second pixel data are read from the memory 142 before being written in the single-line delay memory 141-31 (step S209), and because presently I=2, step S224 is executed in which horizontal pixel data are created. Specifically, by adding the product of the first pixel data already stored in the single-pixel delay memory and coefficient KX shown in FIG. 15, and the product of the second pixel data and coefficient KX, enlarged second pixel data are generated. A method of horizontal interpolation including coefficient KX is described below with reference to FIG. 16.

The enlarged second pixel data are stored as the second pixel data obtained after performing enlargement in the memory 142-3 (step S214). The second pixel data read from the memory 142-1 are stored as the third pixel data obtained after performing enlargement in the memory 142-3, and are written in the single-pixel delay memory 141-33 (step S215). Similarly, the above-described sequential pixel data processes are repeatedly performed until I=K/2. When I=K/2, enlargement for one horizontal line is completed.

Next, step S218 is executed in which it is determined whether H=1. Since H presently represents the first line, 1 is added to H (step S219), and setting I=1 and F=1 are used so as to read pixel data in the second horizontal line vertically adjacent to the first horizontal line (steps S220 to S207). The above-described processes in steps S208 and S209 are performed, and subsequently, vertical pixel data are created because presently H=2 (steps S210 and S211).

The vertical pixel data are used as pixel data in the second line after enlargement. The vertical pixel data are obtained from an arithmetical operation using coefficient KY, based on the first line pixel data already stored in the single-line delay memory 141-31 shown in FIG. 15, and the second line pixel data.

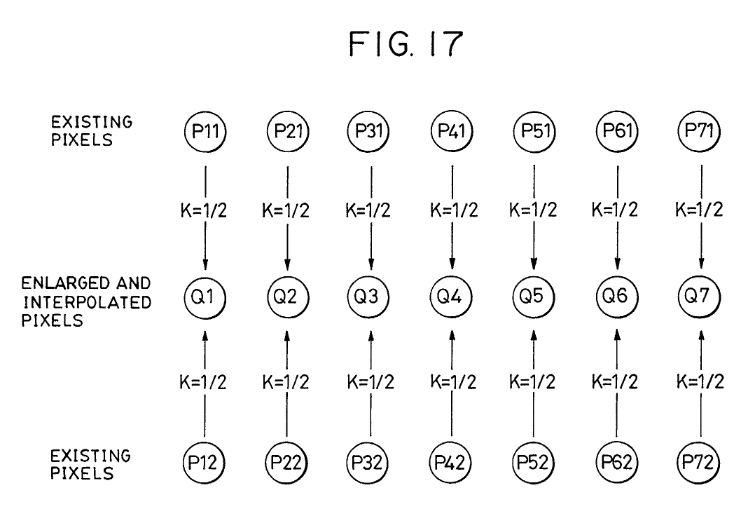

A method of vertical interpolation including coefficient KY is described below with reference to FIG. 17.

Also the second line pixel data obtained after performing enlargement are processed in the sequential horizontal enlargement in steps S212 to 216. When the second line after enlargement are generated (“YES” in step S217), steps S218 to S221 are executed in which flag F is inspected. At present, F=1. Thus, by setting I=1 and F=0, and reading the second line pixel data read from the memory 142-1 and stored in the line delay memory 141-31 (step S223), the sequential enlargement for the horizontal direction is repeatedly performed to create third line pixel data after enlargement.

At present, H=2 (step S218). Thus, 1 is added to H (step S219), and it is determined whether H represents the last line (step S220). If H does not represent the last line, sequential enlargement processes in steps S207 to S220 are repeatedly performed again. When enlargement for the L/2-th line as the last line ends, the entire enlargement is completed.

In FIG. 15 as a block diagram illustrating a method of enlargement, only the memory 142 and part of the signal processing circuit 141 that is related to enlargement are shown, and the memory control unit is omitted.

In the signal processing circuit 141, the enlargement/reduction circuit 141-3 includes a vertical interpolation unit and a horizontal interpolation unit. The vertical interpolation unit consists of a single-line delay memory 141-31 and a multiplier 141-32 for performing multiplication using coefficient KY, while the horizontal interpolation unit consists of a single-pixel delay memory 141-33 and a multiplier 141-34 for performing multiplication using coefficient KX.

Just after the reading of pixel data for a previous line is performed, pixel data for the present line, which are being read, are written in the single-line delay memory 141-31 of the vertical interpolation unit. By way of example, in vertical interpolation using pixel data in the first and second lines, the first line pixel data stored in the single-line delay memory 141-31 are read, and the read pixel data and the second line pixel data are used to perform interpolation operations. At the same time, the second line pixel data used in the interpolation are written in an empty region of the single-line delay memory 141-31 generated by the reading of the first line pixel data. Pixel data, output from the vertical interpolation unit used in the present interpolation, are written in the single-pixel delay memory 141-33 of the horizontal interpolation unit just after reading the image data. In other words, in horizontal interpolation using the first and second pixel data, the first pixel data stored in the single-pixel delay memory 141-33 are read, and the read pixel data and the second pixel data output from the vertical interpolation unit are used to perform horizontal interpolation operations. At the same time, the second pixel data used in the interpolation are written in the single-pixel delay memory 141-33.

Input to the vertical interpolation unit and output from data-format transformation circuit 141-35 are impossible in the same frame memory. However, input to the vertical interpolation unit from the memory 142-1, 142-2 or 142-3, or output from data-format transformation circuit to the memory 142-1, 142-2 or 142-3 is possible.

The description of the flowchart shown in FIG. 13 relates to the case where an output from the memory 142-1 is input to the vertical interpolation unit via the memory control, and an output from the horizontal interpolation unit is transformed by the data-format transformation circuit 141-35 to have a data format adapted for the video-signal generating circuit before being stored in the memory 142-3 via the memory control unit. At this time, in the memory 142-2, image data, obtained by using the data-format transformation circuit 141-35 to simply transform image data in memory 142-1, are stored, and the video-signal generating circuit generates and outputs video signals (image signal) to the TV monitor 3.

FIG. 16 shows a method of enlargement interpolation in the horizontal direction.

In FIG. 16, pixels before enlargement indicate data stored in the memory 142-1 shown in FIG. 15, and are represented by P1 to P4. Pixels after enlargement indicate data stored in the memory 142-3 shown in FIG. 15, and are represented by Q1 to Q7. Coefficient K corresponding to coefficient KX used for enlargement interpolation in the horizontal direction described with reference to FIG. 15.

Pixel P1 is multiplied by coefficient “K=1” to generate pixel Q1. Pixel P2 is processed to generate pixel Q2 by interpolation operations in which pixels P1 and P2 are multiplied by coefficient “K=½”. Pixel P2 is also multiplied by coefficient K=1 to generate pixel Q3. Pixel Q4 is interpolated as same as pixel Q2 is interpolated. Pixel Q5 is interpolated the same as pixels Q1 and Q3 are interpolated. Pixel Q6 is interpolated the same as pixels Q2 and Q4 are interpolated. Pixel Q7 is interpolated the same as pixels Q1, Q3, and Q5 are interpolated. In other words, two adjacent pixels in the horizontal direction are respectively multiplied by coefficients to generate a new interpolation pixel between the two pixels. In FIG. 16, approximate interpolation for an image having an enlargement factor of 200% is shown. Accordingly, when the enlargement factor changes, coefficient K changes, and pixels used for enlargement also change.

FIG. 17 shows a method of enlargement interpolation in the vertical direction.

In FIG. 17, existing pixels in two horizontal rows are represented by P11 to P71 and P12 to P72, and pixels generated by enlargement interpolation based on the existing pixels in two horizontal rows are represented by Q1 to Q7. Coefficient K corresponds to enlargement-interpolation coefficient KY described with reference to FIG. 15. Two adjacent pixels in the vertical direction are respectively multiplied by coefficient K to generate a new interpolation pixel between the two pixels. In FIG. 17, approximate interpolation for an image having an enlargement factor of 200% is shown. Accordingly, when the enlargement factor changes, coefficient K changes, and pixels for enlargement also change, which is similar to the enlargement interpolation in the horizontal direction.

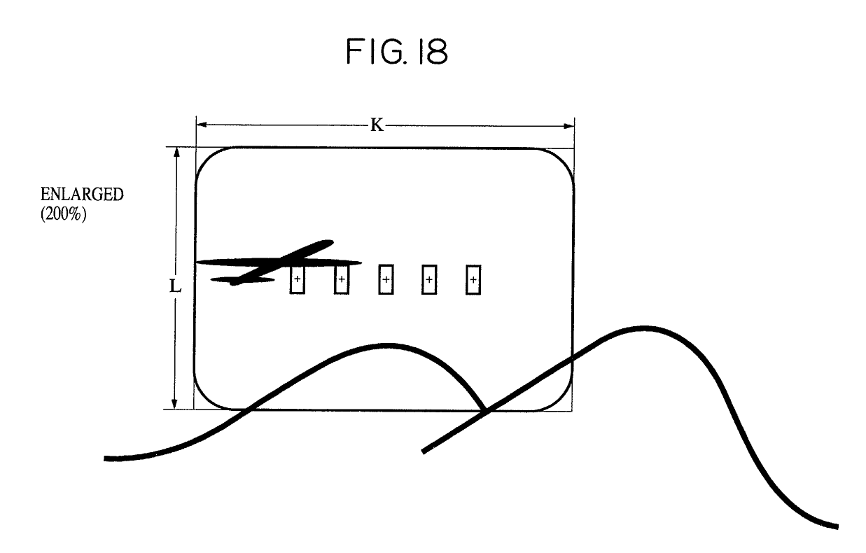

FIG. 18 shows a view obtained by using the enlargement illustrated in FIG. 13 to enlarge the region shown in FIG. 14 at an enlargement factor of 200%. Compared to the image shown in FIG. 7A, it is found from FIG. 18 that the airplane is not out of but is displayed on the TV monitor 3, even after enlargement.

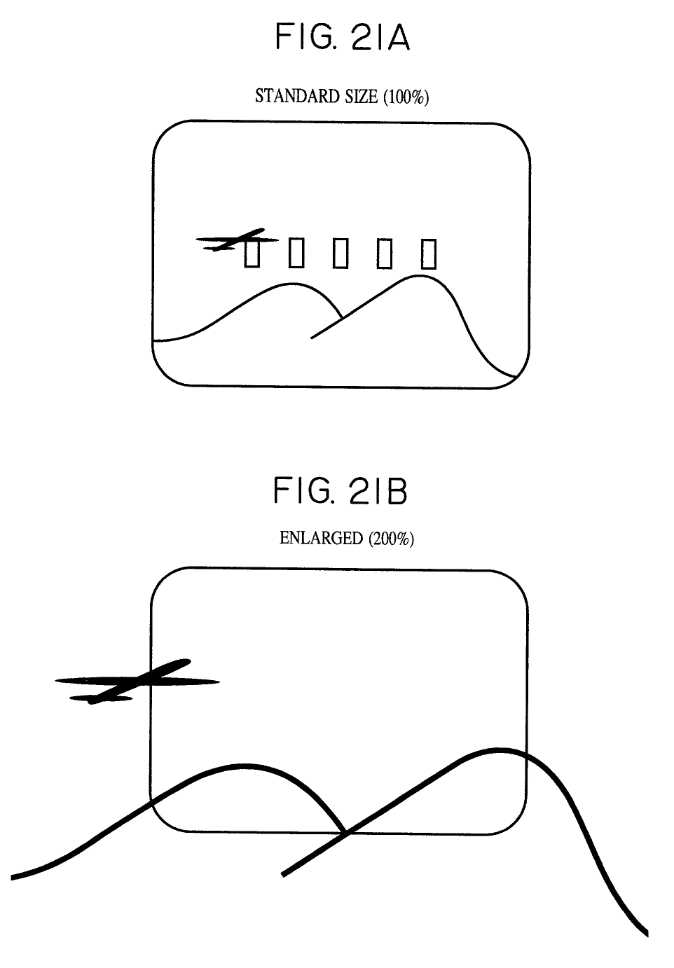

In FIG. 18, for a facile understanding of advantages of the first embodiment, in order that FIG. 18 may be compared with FIG. 7A or 21A, the enlarged view is displayed as a view finder, with the focus detection points superimposed thereon.

According to the first embodiment, in the case where an image is viewed, when enlarged display is necessary, enlarged display is performed using a focus detection point used for focus adjustment as a reference point. Thus, reproduction reflecting a photographic purpose can be performed, and viewers can feel enjoyment.

Second Embodiment

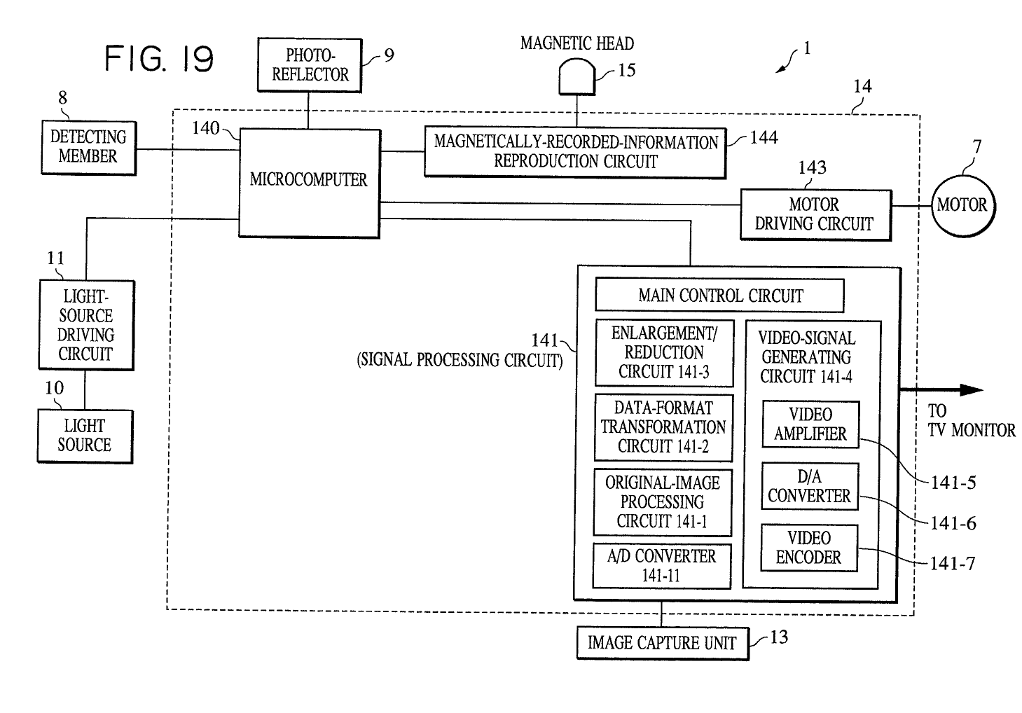

FIG. 19 shows a block diagram of a photo-video player according to a second embodiment of the present invention.

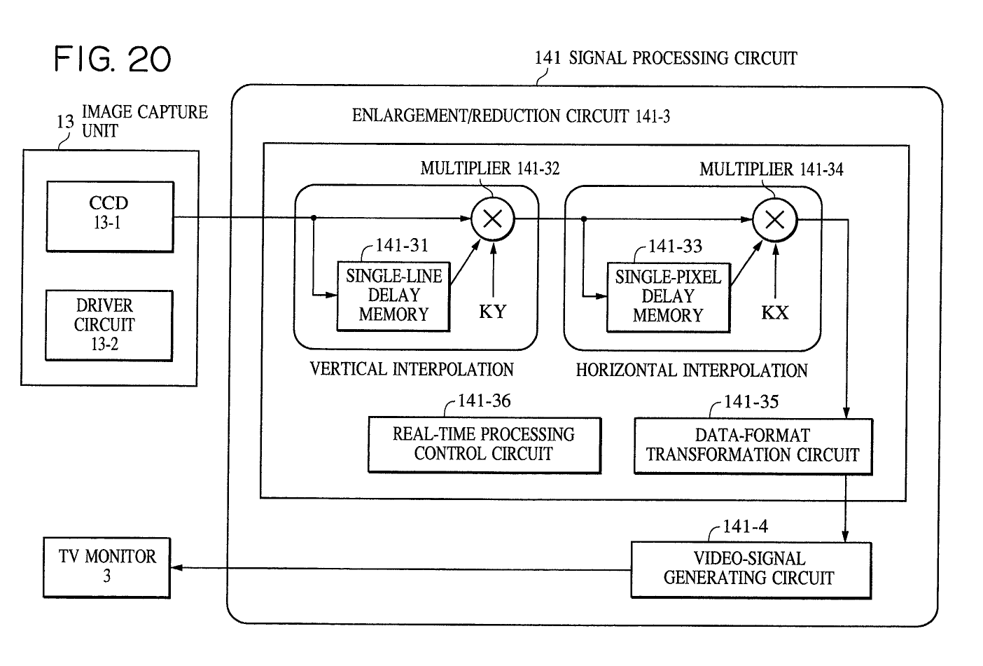

The photo-video player according to the second embodiment differs in structure from the above-described first embodiment, and does not need an image memory. Specifically, as shown in FIG. 20, in the second embodiment, image data from the image capture unit 13 are processed for enlargement in real time, and the processed data are displayed on the monitor screen 3.

In the first embodiment, after image data are stored in memories, enlargement is performed. However, in the second embodiment, by controlling enlargement in real time, the need for the image memory is eliminated. Processing in the second embodiment is similar to the processing in the first embodiment but does not need an image memory. Accordingly, a simplified circuit arrangement is realized at a low cost, and greater enjoyment can be given to a viewer.

In the case where enlargement for the region shown in FIG. 14 is performed, horizontal and vertical pixels are measured by a real-time process control circuit, and a region to be enlarged is extracted for enlargement.

When enlargement is initiated, a change occurs in the image on the TV monitor 3. However, the standard image is switched to the enlarged image, without a particular difficulty. In addition, the enlarged image is switched to the standard image.

According to the foregoing embodiments, by displaying, on the TV monitor 3, an image enlarged using as a reference point a focus detection point used in image capture, the need for manual operations preventing a main subject from being out of the screen of the TV monitor 3 is eliminated, which gives enjoyment to a viewer.

In addition, by displaying, on the TV monitor 3, an image enlarged using as a reference point a focus detection point used in image capture, a captured main subject cannot be out of the screen of the TV monitor 3, and the main subject can be securely viewed.

Moreover, by displaying, on the TV monitor 3, an image enlarged using as a reference point a focus detection point used in image capture, reproduction reflecting a photographic purpose can be performed.

What is claimed is:

1. An apparatus for displaying images recorded by a camera, said apparatus comprising:
reading means for reading information of a focus area used in image capture; and
output means for outputting, based on the focus area information read by said reading means, signals for displaying images.

2. An apparatus according to claim 1, wherein the focus area information read by said reading means represents a position of said focus area used in the image capture.

3. An apparatus according to claim 1, wherein said output means processes the images recorded by said camera so that a position of said focus area used in the image capture is centered in displaying, and outputs signals for displaying the processed images.

4. An apparatus according to claim 1, wherein said output means uses as a reference point a position of said focus area used in the image capture to enlarge the images recorded by said camera, and outputs signals for displaying the enlarged images.

5. An apparatus according to claim 1, wherein said reading means includes a magnetic head for reading magnetic information recorded on a photographic film for said camera.

6. An apparatus for displaying images recorded by a camera, said apparatus comprising:
an image-capture sensor for capturing images optically recorded on a photographic film;
reading means for reading information magnetically recorded on the photographic film; and
output means for processing and outputting the images captured by the image-capture sensor by using, from the information read by said reading means, information of a focus area used in image capture.

7. An apparatus according to claim 6, further comprising storage means for storing images captured by said image-capture sensor, wherein said output means processes and outputs images stored in said storage means.

8. An apparatus according to claim 6, wherein said output means processes the images recorded by said camera so that a position of said focus area used in image capture is centered in displaying, and outputs signals for displaying the processed images.

9. An apparatus according to claim 6, wherein said output means uses as a reference point a position of said focus area used in image capture to enlarge the images recorded by said camera, and outputs signals for displaying the enlarged images.

10. A method for displaying images recorded by a camera comprising:
reading information of a focus area used in image capture; and
outputting, based on the focus area information read in the reading step, signals for displaying images.

11. A method according to claim 10, wherein the focus area information read in the reading step represents a position of the focus area in the image capture.

12. A method according to claim 10, wherein the outputting step includes processing the images recorded by the camera so that a position of the focus area used in the image capture is centered in displaying, and outputting signals for displaying the processed images.

13. A method according to claim 10, wherein the outputting step includes using a position of the focus area used in the image capture as a reference point to enlarge the images recorded by the camera, and outputting signals for displaying the enlarged image.

14. A method according to claim 10, wherein the reading step includes reading magnetic information recorded on a photographic film for the camera by a magnetic head.

15. A method for displaying images recorded by a camera comprising:
capturing images optically recorded on photographic film by an image-capture sensor;
reading information magnetically recorded on the photographic film; and
processing and outputting the images captured by the image-capture sensor including using information of a focus area used in the image capture from information read in the reading step.

16. A method according to claim 15, further comprising the step of storing images captured by the image-capture sensor, and wherein the processing and outputting step processes and outputs the stored images.

17. A method according to claim 10, wherein the processing and outputting step includes processing the images recorded by said camera so that a position of the focus area used in image capture is centered in displaying and outputting signals for displaying the processed images.

18. A method according to claim 10, wherein the processing and outputting step includes using a position of the focus area used in image capture as a reference point to enlarge the images recorded by the camera, and outputting signals for displaying the enlarged images.
